(19) United States
(12) Patent Application Publication
(10) Pub. No.: US 2013/0068726 A1
(43) Pub. Date: Mar. 21, 2013

(54) PLASMA PROCESSING APPARATUS

(71) Applicants: Shogo Okita, Hyogo (JP); Sumio Miyake, Kyoto (JP)

(72) Inventors: Shogo Okita, Hyogo (JP); Sumio Miyake, Kyoto (JP)

(21) Appl. No.: 13/699,920

(22) PCT Filed: May 25, 2011
(86) PCT No.: PCT/JP2011/002908

§ 371 Date: Nov. 26, 2012

(30) Foreign Application Priority Data
May 27, 2010 (JP) 2010-121094

(51) Int. Cl. B44C 1/22

(52) U.S. Cl. CPC B44C 1/227
USPC 216/59; 156/345.24

(57) ABSTRACT

A plasma processing apparatus 1 includes a stock unit 2, a processing chamber 5, and an alignment chamber 4. The stock unit 2 supplies and collects a conveyable tray 7 and accommodates a wafer W in each of the plurality of accommodation holes 7a penetrating through in the thickness direction. In the processing chamber 5, plasma processing is performed to the wafers W accommodated in the tray 7 supplied from the stock unit 2. The alignment chamber 4 includes a rotary table 41 on which the tray 7 before being subjected to plasma processing is placed, and positioning of the wafer W on the rotary table 41 is carried out. A wafer presence-absence determining unit 6a of the control apparatus 6 determines whether the wafer W is present in each of the accommodation holes 7a of the tray 7 placed on the rotary table 41 of the alignment chamber 4, based on a signal from the wafer presence-absence detecting sensors 44A and 44B.

### TECHNICAL FIELD

The present invention relates to a plasma processing apparatus such as a dry etching apparatus or a CVD apparatus.

### BACKGROUND ART

In connection with plasma processing apparatuses, wafers as objects to be processed are held by a support pedestal, which is referred to as a susceptor and is provided in a chamber. Next, a high-frequency voltage is applied to the chamber in the air-tight state, while gas for generating plasma is supplied, so as to generate plasma in the chamber. By exposing the wafers to plasma, the wafers are subjected to plasma processing such as dry etching.

With such a plasma processing apparatus, in order to allow a plurality of wafers to be held by the support pedestal, a tray that can accommodate a plurality of wafers is used (e.g., Patent Document 1). The tray has a plurality of accommodation holes each having a diameter slightly greater than that of each wafer. A margin portion is provided so as to project from the bottom edge of the inner circumference portion of each accommodation hole toward the inner side of the accommodation hole. The margin portion holds the outer edge of the wafer from below to accommodate the wafer inside the accommodation hole. The support pedestal includes a tray placing portion where the tray is placed and a plurality of wafer holding portions provided so as to project upwardly from the tray placing portion. When the tray is placed on the tray placing portion of the support pedestal, the wafer holding portions enter the accommodation holes of the tray from below, and lift and hold the wafers at the margin portion. The wafers held by the wafer holding portions of the support pedestal are electrostatically attracted by an electrostatic attracting apparatus provided in each of the wafer holding portions. The wafers are cooled by a cooling gas (e.g., helium gas) that is supplied from a cooling gas supplying duct provided inside the support pedestal.

### PRIOR ART DOCUMENT

### Patent Document

Patent Document 1: JP 2009-147375 A

### SUMMARY OF THE INVENTION

### Problems to be Solved by the Invention

However, with the conventional plasma processing apparatus as described above, in which a plurality of wafers are held by the support pedestal altogether by the tray having the accommodation holes penetrating through in the thickness direction, what matters is whether or not the wafers are actually accommodated in the respective accommodation holes. That is, in the case where there is any accommodation hole where no wafer is present (not accommodating the wafer) among a plurality of accommodation holes provided to the tray, the wafer holding portion corresponding to the accommodation hole with no wafer will directly be exposed to plasma. When the wafer holding portion is exposed to the plasma, not only the wafer holding portion but also the entire plasma processing apparatus may be damaged.

Accordingly, an object of the present invention is to provide a plasma processing apparatus that can prevent the wafer holding portion of the support pedestal from being directly exposed to plasma from any accommodation hole of the tray where no wafer is present.

### Means for Solving the Problems

A first mode of the present invention provides a plasma processing apparatus that includes: a conveyable stock unit for supplying and collecting a tray that accommodates a wafer in each of a plurality of accommodation holes penetrating through in a thickness direction; a processing unit that performs plasma processing to each wafer accommodated in the tray supplied from the stock unit; an alignment unit that has a table on which the tray before being subjected to the plasma processing is placed, positioning of the wafer on the table being performed at the alignment unit; and a wafer presence-absence detecting unit that detects whether or not the wafer is present in each of the accommodation holes of the tray placed on the table of the alignment unit.

Specifically, the plasma processing apparatus further includes a conveying mechanism that conveys the tray, and a conveyance control unit that causes the tray on the table to be returned to the stock unit instead of the tray being transferred to the processing unit by the conveying mechanism, when the wafer presence-absence detecting unit detects that the wafer is not accommodated in any of the accommodation holes of the tray placed on the table.

Before the plasma processing in the processing unit, the tray is placed on the table of the alignment unit for positioning. To the tray on the table, the wafer presence-absence detecting unit performs detection as to whether or not the wafer is present in each of the accommodation holes. As a result, when there is any accommodation hole where no wafer is present out of the plurality of accommodation holes provided to the tray, the tray can be prevented from being subjected to plasma processing in the processing unit.

Specifically, the wafer presence-absence detecting unit includes an optical sensor for detecting the wafer accommodated in each of the accommodation holes of the tray on the table, and a determining unit that determines whether or not the wafer is present in each of the accommodation holes provided to the tray, based on a signal from the optical sensor.

Preferably, the optical sensor includes: a light projector that projects inspection light toward the tray; and a light receiver that is arranged at a position where the inspection light is blocked and unreceived when the wafer is accommodated in any of the accommodation holes of the tray, and where the inspection light is received when the wafer is not accommodated in any of the accommodation holes of the tray.

With this structure, since presence-absence of the wafer in each of the accommodation holes is determined by whether or not the inspection light from the light projector is received by the light receiver, that is, whether or not the inspection light is blocked by the wafer, the determining unit can accurately determine whether or not the wafer is present in each of the accommodation holes.

Alternatively, the wafer presence-absence detecting unit includes: an imaging unit that images the accommodation holes of the tray on the table from above; and a determining unit that determines whether or not the wafer is present in each of the accommodation holes of the tray, based on an image obtained by the imaging unit.

The table may be a rotary table that rotates the tray within a horizontal plane. In this case, the wafer presence-absence detecting unit detects whether or not the wafer is present in each of the accommodation holes provided to the tray, while the tray is rotated by the rotary table.

With this structure, whether or not the wafer is present for each of the plurality of accommodation holes can be detected by one optical sensor whose projection direction of the inspection light is fixed, or by one imaging unit whose field of view is fixed, which is included in the wafer presence-absence detecting unit.

The alignment unit includes: a centering mechanism that performs center position alignment of the tray relative to the rotary table; and a rotary direction positioning unit that performs positioning in the rotation direction of the tray while the tray is rotated by the rotary table. The wafer presence-absence detecting unit detects whether or not the wafer is present in each of the accommodation holes provided to the tray, while the positioning in the rotation direction is performed by the rotary direction positioning unit.

With this structure, since whether or not the wafer is present in each of the accommodation holes can be detected during the positioning of the tray in the rotation direction, the time required for processing in the alignment unit can be reduced. This can contribute toward a takt time improvement of the whole plasma processing apparatus.

The plasma processing apparatus may further include an alarm issuing unit that issues an alarm when the wafer presence-absence detecting unit detects that the wafer is not accommodated in any of the accommodation holes of the tray.

The second mode of the present invention provides a plasma processing method, including: conveying from a stock unit to an alignment unit a tray that accommodates a wafer in each of a plurality of accommodation holes penetrating through in a thickness direction, and placing the tray on a table; detecting whether or not the wafer is present in each of the accommodation holes of the tray on the table of the alignment unit; conveying the tray from the alignment unit to the processing unit when the wafer is present in each of the accommodation holes of the tray on the table, and executing plasma processing; and returning the tray from the alignment unit to the stock unit when the wafer is absent in any of the accommodation holes of the tray on the table.

### Effects of the Invention

In the present invention, at the tray positioning stage in the alignment unit before plasma processing to the wafers is performed in the processing unit, whether or not the wafer is present in each of the accommodation holes provided to the tray is determined. As a result, when there is any accommodation hole where no wafer is present out of the plurality of accommodation holes provided to the tray, the tray can be returned to the stock unit instead of being transferred to the processing unit. Accordingly, it becomes possible to prevent the wafer holding portion of the processing unit from being directly exposed to plasma from the accommodation hole of the tray where no wafer is present. Thus, not only the wafer holding portion but also the entire plasma processing apparatus can be prevented from being damaged.

### BRIEF DESCRIPTION OF THE DRAWINGS

FIG. 1 is a perspective view of a plasma processing apparatus according to one embodiment of the present invention.

FIG. 2 is a cross-sectional plan view of the plasma processing apparatus according to one embodiment of the present invention.

FIG. 3 is a cross-sectional side view of the plasma processing apparatus according to one embodiment of the present invention.

FIG. 4 is a cross-sectional side view of the plasma processing apparatus according to one embodiment of the present invention.

FIG. 5A is a perspective view of a tray included in the plasma processing apparatus according to one embodiment of the present invention.

FIG. 5B is a side cross-sectional view of the tray included in the plasma processing apparatus according to one embodiment of the present invention.

FIG. 6 is a block diagram showing the operation system of the plasma processing apparatus according to one embodiment of the present invention.

FIG. 7 is a cross-sectional perspective view of an alignment chamber included in the plasma processing apparatus according to one embodiment of the present invention.

FIG. 8 is an operation explanatory view of a centering mechanism in the alignment chamber included in the plasma processing apparatus according to one embodiment of the present invention.

FIG. 9 is a diagram showing the positional relationship among a notch detecting sensor, a wafer presence-absence detecting sensor inside the alignment chamber, and the tray included in the plasma processing apparatus according to one embodiment of the present invention.

FIG. 10A is a perspective view of a susceptor in the processing chamber included in the plasma processing apparatus according to one embodiment of the present invention.

FIG. 10B is a side cross-sectional view of the susceptor in the processing chamber included in the plasma processing apparatus according to one embodiment of the present invention.

FIG. 11A is a diagram showing the procedure of placing the tray on the susceptor in the processing chamber included in the plasma processing apparatus according to one embodiment of the present invention.

FIG. 11B is a diagram showing the procedure of placing the tray on the susceptor in the processing chamber included in the plasma processing apparatus according to one embodiment of the present invention.

FIG. 11C is a diagram showing the procedure of placing the tray on the susceptor in the processing chamber included in the plasma processing apparatus according to one embodiment of the present invention.

FIG. 12A is a diagram showing the procedure of placing the tray on the susceptor in the processing chamber included in the plasma processing apparatus included in one embodiment of the present invention.

FIG. 12B is a diagram showing the procedure of placing the tray on the susceptor in the processing chamber included in the plasma processing apparatus according to one embodiment of the present invention.

FIG. 12C is a diagram showing the procedure of placing the tray on the susceptor in the processing chamber included in the plasma processing apparatus according to one embodiment of the present invention.

FIG. 13 is a side cross-sectional view of the plasma processing apparatus according to one embodiment of the present invention.

FIG. 14 is a flowchart showing the work procedure in the alignment chamber of the plasma processing apparatus according to one embodiment of the present invention.

FIG. 15A is a perspective view showing the plasma processing apparatus according to one embodiment of the present invention.

FIG. 15B is a side cross-sectional view of the plasma processing apparatus according to one embodiment of the present invention.

FIG. 15C is a side cross-sectional view of the plasma processing apparatus according to one embodiment of the present invention.

FIG. 15D is a side cross-sectional view of the plasma processing apparatus according to one embodiment of the present invention.

FIG. 16 is a side cross-sectional view of a plasma processing apparatus according to a modified embodiment of the present invention.

### MODE FOR CARYYING OUT THE INVENTION

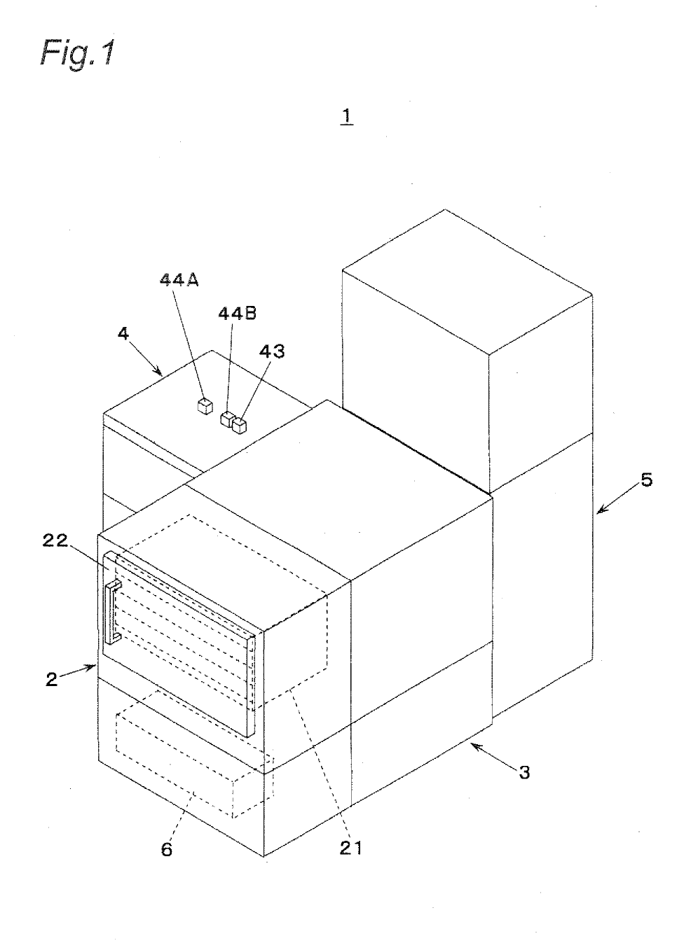

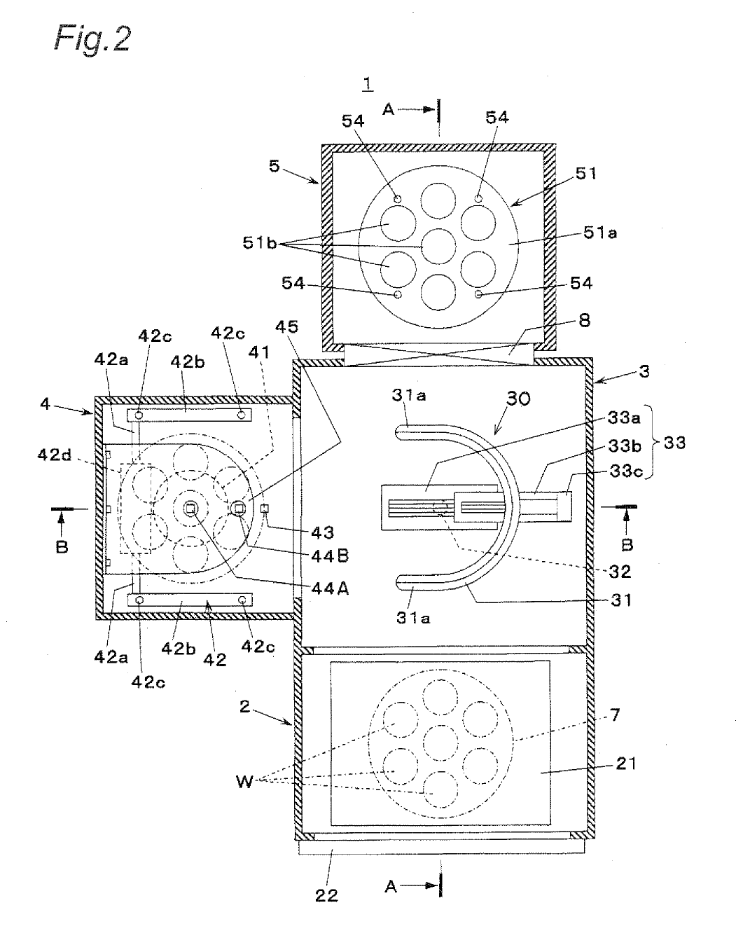

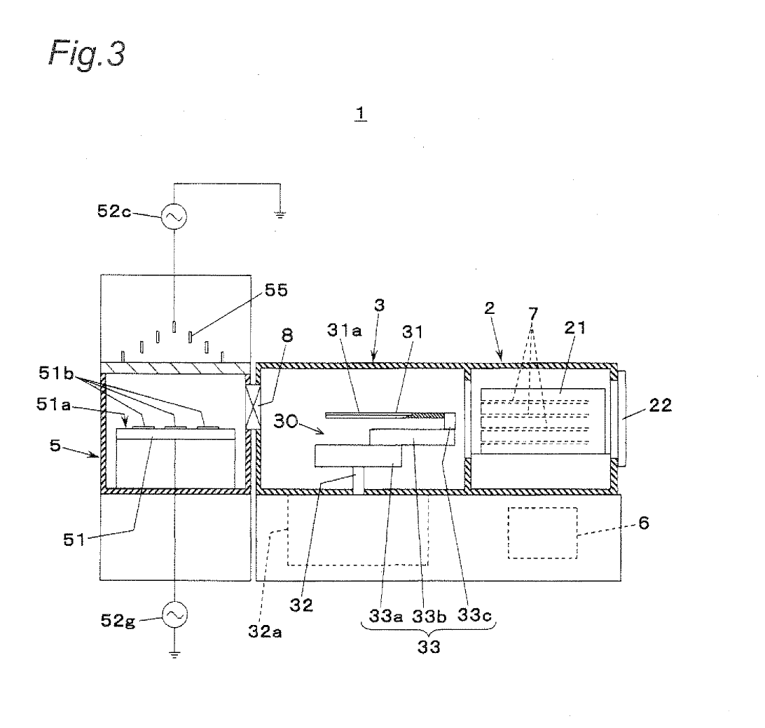

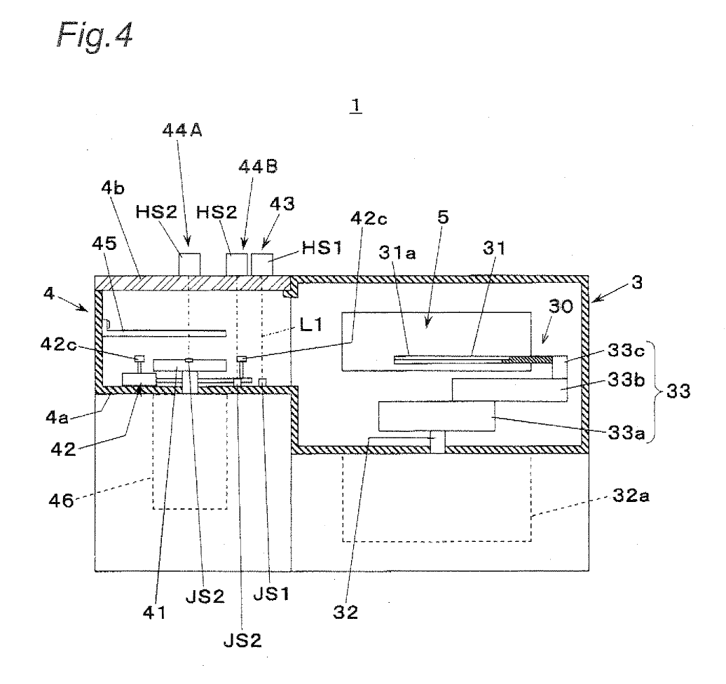

In the following, with reference to the drawings, a description will be given of an embodiment of the present invention. In FIGS. 1 to 4, a plasma processing apparatus 1 according to one embodiment of the present invention is configured to perform plasma processing (e.g., dry etching) to any object to be processed, and includes a stock unit 2, a conveyance chamber (conveyance unit) 3, an alignment chamber (alignment unit) 4, a processing chamber (processing unit) 5, and a control apparatus 6 (FIGS. 1 and 3). Here, FIG. 3 is a cross-sectional view taken along line A-A shown in FIG. 2, and FIG. 4 is a cross-sectional view taken along line B-B shown in FIG. 2.

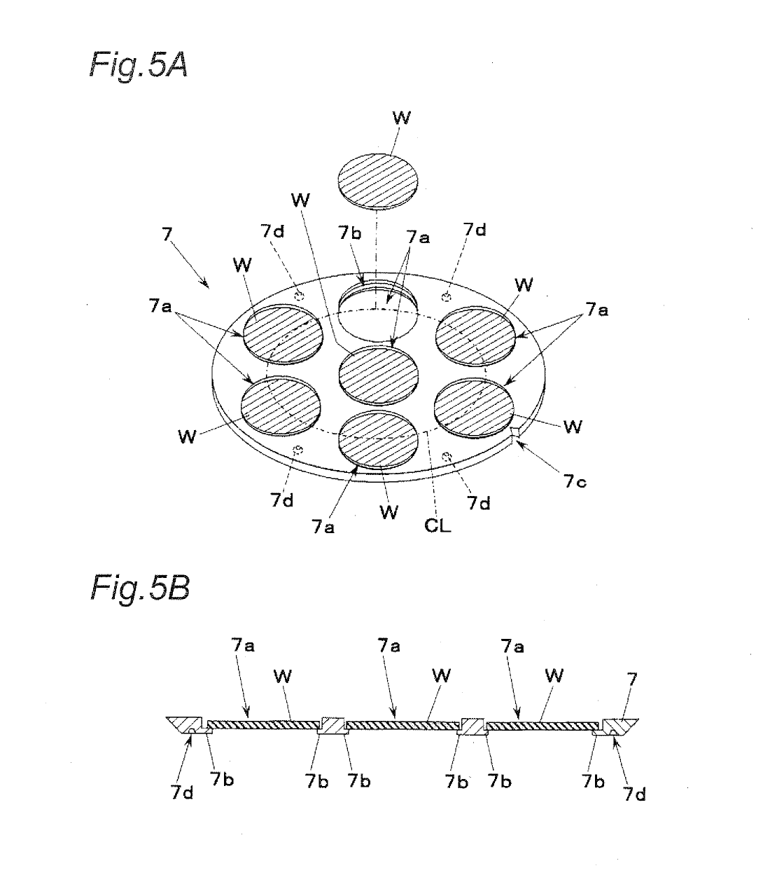

With the plasma processing apparatus 1, as shown in FIGS. 5A and 5B, a tray 7 capable of being conveyed is used, so that several wafers W as the objects to be processed can simultaneously be processed. The tray 7 is a thin disc-like member, and is made of an electrically insulating material such as a ceramic material. The tray 7 is provided with a plurality of (seven herein) circular accommodation holes 7a. The accommodation holes 7a are provided so as to penetrate through in the thickness direction and each have a diameter slightly greater than that of each wafer W. At the bottom edge portion of the inner circumference portion of each accommodation hole 7a, a ring-like margin portion 7b projecting toward the inner side of the accommodation hole 7a is provided. The margin portion 7b holds the outer edge of the bottom face of the wafer W accommodated in the accommodation hole 7a. In the state where the outer edge of the wafer W is held by the margin portion 7b from below and the wafer W is accommodated in the accommodation hole 7a, the bottom face of the wafer W is exposed downwardly at the accommodation hole 7a (FIG. 5B).

As shown in FIG. 5A, the tray 7 according to this embodiment is structured such that one accommodation hole 7a arranged at the center position of the tray 7 accommodates one wafer W. Further, the tray 7 is structured such that six accommodation holes 7a having their respective centers aligned on a phantom circle CL about the center position of the tray 7 at regular intervals accommodate six wafers W, respectively.

In FIGS. 1, 2, and 3, the stock unit 2 of the plasma processing apparatus 1 according to the present embodiment includes a cassette 21 that accommodates a plurality of trays 7 (in which a plurality of accommodation holes 7a of each tray 7 accommodate the wafers W, respectively), so that the trays 7 can be taken out therefrom or put therein. The cassette 21 is externally accessible via an opening-closing door 22 provided at the stock unit 2.

In FIGS. 2, 3, and 4, a conveyance chamber 3 is provided to be adjacent to the stock unit 2. The conveyance chamber 3 accommodates therein a conveying mechanism 30 for conveying the tray 7. The conveying mechanism 30 is provided with a conveyance arm 31. The conveyance arm 31 has two parallel projecting portions 31a to form a U-shape in plan view, and is attached to a horizontal shifting mechanism 33 provided at the top portion of a rotary shaft 32 being rotatable about the vertical axis.

In FIGS. 2, 3, and 4, the horizontal shifting mechanism 33 includes: a base stage 33a fixed to the top end portion of the rotary shaft 32 and extending in the direction within a horizontal plane; a bottom stage 33b provided to the base stage 33a so as to be shiftable in the extending direction of the base stage 33a; and a top stage 33c provided to the bottom stage 33b so as to be shiftable in the extending direction of the base stage 33a. The conveyance arm 31 is attached to the top stage 33c in the state where the extending directions of the two projecting portions 31a are agreed with the extending direction of the base stage 33a.

The conveyance arm 31 rotates within the horizontal plane by the rotation of the rotary shaft 32. Further, as being interlocked with the shifting movement of the bottom stage 33b of the horizontal shifting mechanism 33 within the horizontal plane relative to the base stage 33a, the top stage 33c shifts within the horizontal plane relative to the bottom stage 33b. This allows the conveyance arm 31 to shift within the horizontal plane.

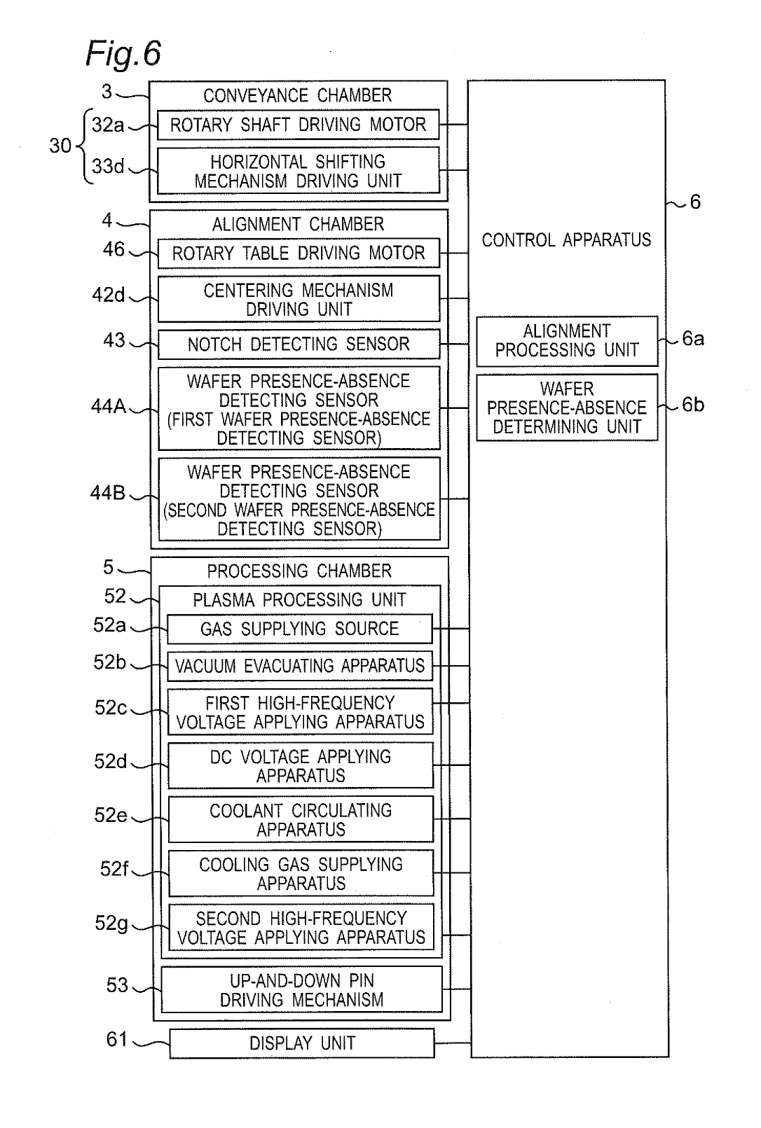

The rotary operation of the conveyance arm 31 within the horizontal plane (the rotary operation of the rotary shaft 32) is achieved by the control apparatus 6 exerting the actuation control of the rotary shaft driving motor 32a (FIGS. 3, 4, and 6). Further, the shifting operation of the conveyance arm 31 within the horizontal plane (the shifting operation of the bottom stage 33b relative to the base stage 33a within the horizontal plane and the shifting operation of the top stage 33c relative to the bottom stage 33b within the horizontal plane) is achieved by the control apparatus 6 exerting the actuation control of the horizontal shifting mechanism driving unit 33d (FIG. 6) provided inside the horizontal shifting mechanism 33. In this manner, the control apparatus 6 allows the conveyance arm 31 to rotate within the horizontal plane. This shifting within the horizontal plane realizes: to convey the tray 7 in the stock unit 2 to the alignment chamber 4; to convey the tray 7 in the alignment chamber 4 to the processing chamber 5; to convey the tray 7 in the processing chamber 5 to the alignment chamber 4; and to convey the tray 7 in the alignment chamber 4 to the stock unit 2.

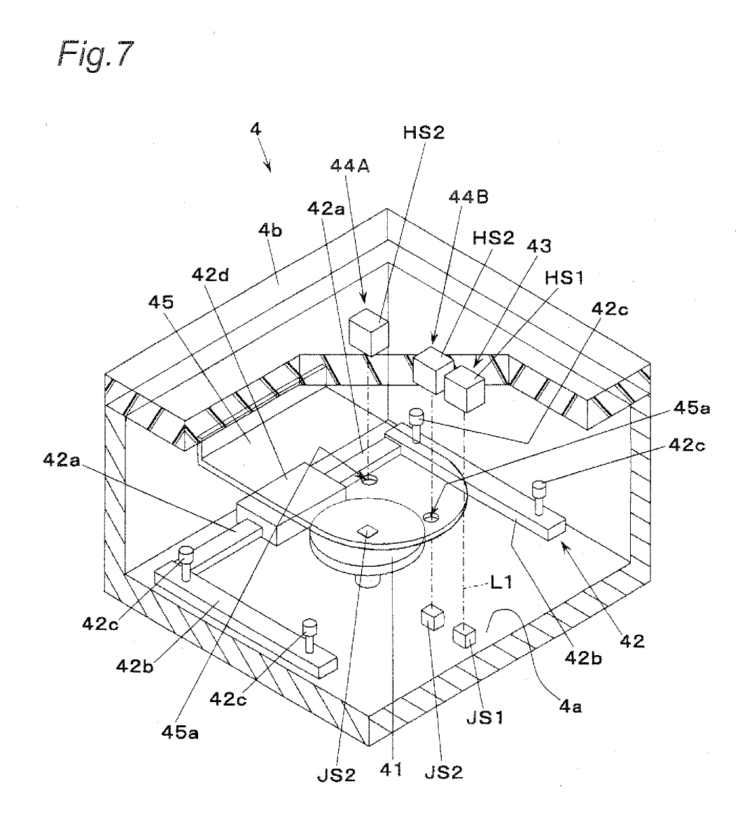

In FIGS. 2 and 4, the alignment chamber 4 is provided adjacent to the conveyance chamber 3. As shown in FIG. 7, the alignment chamber 4 includes therein a rotary table 41, a centering mechanism 42, a notch detecting sensor 43a being a transmission type optical sensor (an optical sensor in which inspection light projected by a light projector is directly received by a light receiver), two wafer presence-absence detecting sensors 44A and 44B each being the transmission type optical sensor likewise, and a tray temporarily placement table 45.

In FIGS. 4 and 7, the rotary table 41 is provided so as to be rotatable within the horizontal plane relative to a bottom plate portion 4a of the alignment chamber 4. On the rotary table 41, the tray 7 (in each accommodation hole 7a of the tray 7, a wafer W is accommodated) supplied from the stock unit 2 by the conveyance arm 31 in the conveyance chamber 3 is placed.

The rotary table 41 rotates by the actuation of a rotary table driving motor 46 (FIGS. 4 and 6) provided below the bottom plate portion 4a, whereby the tray 7 on the rotary table 41 rotates within the horizontal plane.

As shown in FIGS. 2, 7, and 8, the centering mechanism 42 includes a pair of longitudinal direction members 42a provided on the bottom plate portion 4a of the alignment chamber 4 so as to approach or become away from each other on the identical axis in synchronization with each other within the horizontal plane, and a pair of lateral direction members 42b having one ends fixed to the longitudinal direction member 42a, respectively, to extend in the direction within the horizontal plane perpendicular to the longitudinal direction member 42a. A total of four abutment members 42c are provided to the lateral direction members 42b, i.e., two at each of the lateral direction members 42b. As the pair of longitudinal direction members 42a approach or become away from each other, the pair of lateral direction members 42b approach or become away from each other accordingly. Here, the operation of approaching or becoming away from each other of the pair of longitudinal direction members 42a (i.e., the operation of approaching or becoming away from each other of thethe pair of lateral direction members 42b) is performed by the control apparatus 6 exerting the actuation control of a centering mechanism driving unit 42d provided between at the pair of longitudinal direction members 42a.

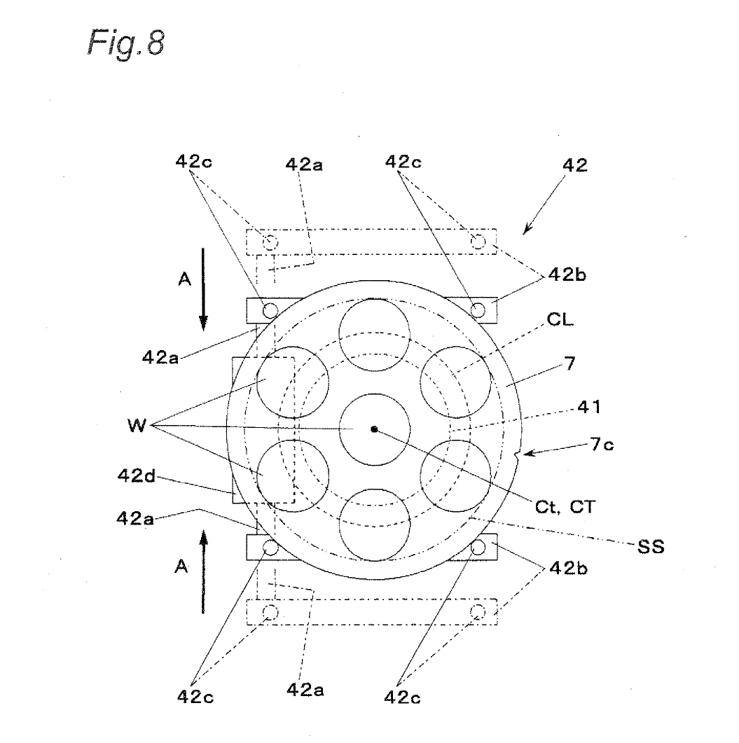

The control apparatus 6 allows the conveyance arm 31 to shift in the conveyance chamber 3 within the horizontal plane, so that the conveyance arm 31 places the tray 7 on the rotary table 41. Thereafter, the control apparatus 6 exerts the actuation control of the centering mechanism driving unit 42d, so that the pair of longitudinal direction members 42a (i.e., the pair of lateral direction members 42b accordingly) are actuated to approach each other (arrow A in FIG. 8). Thus, a total of four abutment members 42c provided to stand from the pair of lateral direction members 42b are caused to abut on the outer edge of the tray 7, so that the tray 7 is clamped (see the abutment members 42c represented by solid line in FIG. 8). Thus, the tray 7 on the rotary table 41 shifts to the position where the center position ct (FIG. 8) of the tray 7 agrees with the center position CT (FIG. 8) of the rotary table 41. Thus, the center position alignment (centering) relative to the rotary table 41 is achieved.

After centering of the tray 7 is achieved, the control apparatus 6 exerts the actuation control of the centering mechanism driving unit 42d such that the pair of longitudinal direction members 42a (i.e., the pair of lateral direction members 42b) become away from each other. Thus, the four abutment members 42c leave the tray 7, and the tray 7 can be rotated by the rotary actuation of the rotary table 41. It is to be noted that, in the present embodiment, as shown in FIG. 8, in the state where the tray 7 is centered by the centering mechanism 42, the outer edge of the rotary table 41 fits inside the inner region of the phantom circle CL of the tray 7.

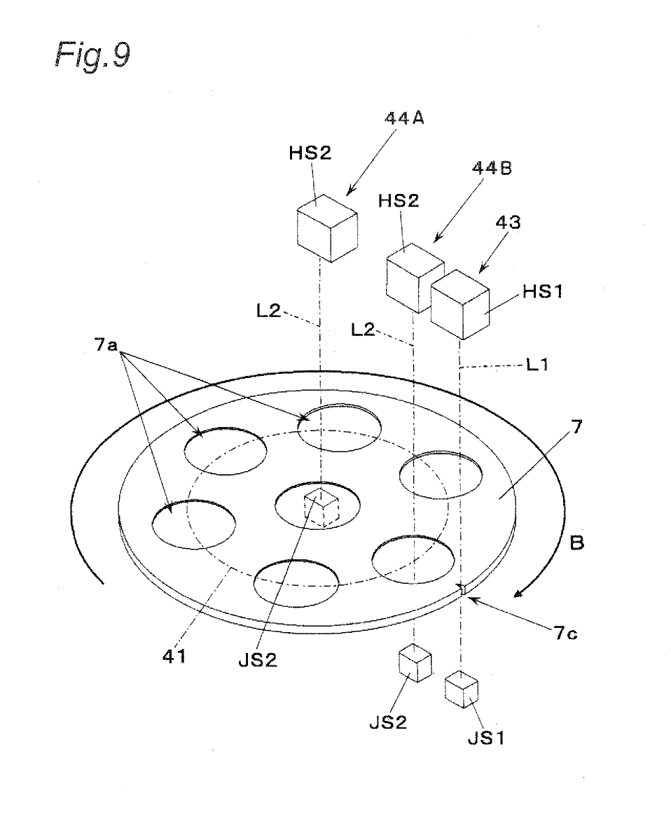

In FIGS. 7 and 9, the notch detecting sensor 43 includes a light projector HS1 that is provided at a ceiling portion 4b of the alignment chamber 4 (FIGS. 4 and 7) to project inspection light L1 downwardly, and a light receiver JS1 provided immediately below the light projector HS1 and on the bottom plate portion 4a. In the present embodiment, the ceiling portion 4b of the alignment chamber 4 is made of a transparent member such as an acrylic plate, and the notch detecting sensor 43 is provided on the top face side of the ceiling portion 4b. Thus, it is structured such that the inspection light L1 projected from the light projector HS1 transmits the ceiling portion 4b and is emitted downwardly. However, the light projector HS1 of the notch detecting sensor 43 may be provided on the bottom face side of the ceiling portion 4b (the same holds true for the two wafer presence-absence detecting sensors 44A and 44B).

In FIG. 9, the light projector HS1 of the notch detecting sensor 43 is disposed at the position where, when the tray 7 centered by the centering mechanism 42 is rotated by the rotary table 41, the inspection light L1 projected by the light projector HS1 can pass through a notch 7c in the vertical direction, the notch 7c being formed by cutting off part of the outer edge of the tray 7. The light receiver JS1 of the notch detecting sensor 43 is disposed at the position where, when the inspection light L1 projected by the light projector HS1 passes through the notch 7c in the vertical direction, the inspection light L1 can be received.

The notch detecting sensor 43 can detect the position of the notch 7c of the tray 7, by observing the light reception state of the light receiver JS1 as to the inspection light L1, while the inspection light L1 is projected from the light projector HS1 in the state where the rotary table 41 on which the tray 7 is placed is rotated (arrow B in FIG. 9). The alignment processing unit 6a of the control apparatus 6 (FIG. 6) recognizes that the rotation angle of the tray 7 (the rotation angle about the rotary shaft of the rotary table 41) at which the position of the notch 7c is detected by the notch detecting sensor 43 as 0 degrees (the origin position). It is to be noted that, the rotary operation of the rotary table 41 in detecting the notch 7c is carried out by the alignment processing unit 6a of the control apparatus 6 exerting the actuation control of the rotary table driving motor 46.

In FIGS. 7 and 9, the two wafer presence-absence detecting sensors 44A and 44B provided to the alignment chamber 4 each include a light projector HS2 that is provided at the ceiling portion 4b of the alignment chamber 4 and that projects inspection light L2 downwardly, and a light receiver JS2 that is provided directly below the light projector HS2 and on the top face of the rotary table 41 (the placement plane of the tray 7) or on the bottom plate portion 4a.

The light projector HS2 of each of the wafer presence-absence detecting sensors 44A and 44B is provided at the position where the inspection light L2 can be emitted to the wafer W accommodated in the accommodation hole 7a provided to the tray 7, which is centered by the centering mechanism 42. When the inspection light L2 passes through the accommodation hole 7a of the tray 7 and the inspection light L2 is received by the light receiver JS2 (FIG. 9), the wafer presence-absence determining unit 6b of the control apparatus 6 (FIG. 6) determines that no wafer W is present in the accommodation hole 7a, which is the target of the detection of whether or not any wafer W is present (wafer presence-absence detection), of the tray 7 (i.e., the wafer W is not accommodated). Further, when the inspection light L2 is reflected from the top face of the wafer W in the accommodation hole 7a and the inspection light L2 is not received by the light receiver JS2, the wafer presence-absence determining unit 6b determines that the wafer W is present in the accommodation hole 7a, which is the target of the wafer presence-absence detection, of the tray 7 (i.e., the wafer W is accommodated). That is, the two wafer presence-absence detecting sensors 44A and 44B included in the plasma processing apparatus 1 according to the present embodiment carries out the wafer presence-absence detection based on whether or not the inspection light L2 emitted to the wafer W accommodated in the tray 7 held by the rotary table 41 is detected. The wafer presence-absence detecting sensors 44A and 44B and the wafer presence-absence determining unit 6b structure the wafer presence-absence detecting unit in the present invention.

As described above, in the present embodiment, the tray 7 accommodates one wafer W in one accommodation hole 7a arranged at its center position, and accommodates six wafers W in six accommodation holes 7a having their respective centers aligned on the phantom circle CL (the circumferential position) about the center position of the tray 7 at regular intervals. In association with this arrangement, there are the two wafer presence-absence detecting sensors, that is, the first wafer presence-absence detecting sensor 44A that performs the wafer presence-absence detection as to one accommodation hole 7a arranged at the center position of the rotary table 41, and the second wafer presence-absence detecting sensor 44B that performs the wafer presence-absence detection as to the six accommodation holes 7a arranged at the circumferential position.

Here, as shown in FIG. 9, the first wafer presence-absence detecting sensor 44A includes the light projector HS2 provided substantially directly above the center position of the rotary table 41, and the light receiver JS2 embedded at the position immediately below the light projector HS2 on the rotary table 41 (i.e., at the center position of the rotary table 41). Further, the second wafer presence-absence detecting sensor 44B includes: the light projector HS2 provided immediately above the position that is outside the outer edge of the rotary table 41 and that is any position in the region inner than a phantom circle SS (FIG. 8) inscribed in the six accommodation holes 7a arranged at the circumferential position of the tray 7 (e.g., any position on the phantom circle CL); and the light receiver JS2 provided on the bottom plate portion 4a immediately below the light projector HS2. Here, as shown in FIG. 7, in order not for the inspection light L2 emitted by the light projector HS2 of each of the wafer presence-absence detecting sensors 44A and 44B to be blocked by the tray temporarily placement table 45, through holes 45a are provided at several places of the tray temporarily placement table 45 penetrating therethrough in the thickness direction.

The second wafer presence-absence detecting sensor 44B that performs the wafer presence-absence detection as to the six accommodation holes 7a at the circumferential position of the tray 7 is one in number. However, by allowing the tray 7 after being centered to be rotated by the rotary table 41, the single second wafer presence-absence detecting sensor 44B can perform the wafer presence-absence detection as to the six accommodation holes 7a at the circumferential position of the tray 7. It is to be noted that, the rotation control of the rotary table 41 is achieved by the wafer presence-absence determining unit 6b of the control apparatus 6 exerting the actuation control of the rotary table driving motor 46.

Further, the wafer presence-absence detection as to the six accommodation holes 7a at the circumferential position of the tray 7, performed by the single second wafer presence-absence detecting sensor 44B is executed when the tray 7 is rotated by the rotary table 41 for 7c by the notch detecting sensor 43. That is, the wafer presence-absence detection is performed in parallel with the notch detection for positioning the rotation angle position of the tray 7. Therefore, the time required for performing processing in the alignment chamber 4 can be reduced. This contributes toward the takt time improvement of the whole plasma processing apparatus 1.

Further, as described above, with the plasma processing apparatus 1 according to the present embodiment, the second wafer presence-absence detecting sensor 44B emits the inspection light L2 to the region that is outside the outer edge of the rotary table 41 and that is inner than the phantom circle SS inscribed to the six accommodation holes 7a arranged at the circumferential position of the tray 7. Therefore, even in the case where no wafer W is present in the accommodation hole 7a, which is the detection target, of the tray 7, the inspection light L2 will not be reflected by the rotary table 41. Accordingly, the wafer presence-absence determining unit 6b of the control apparatus 6 can be prevented from erroneously recognizing that the wafer W is present as to the accommodation hole 7a in which no wafer W is present.

In FIGS. 2 and 3, the processing chamber 5 is connected to the conveyance chamber 3 via a gate valve 8. In the state where the gate valve 8 is closed, the processing chamber 5 functions as a vacuum container being independent of the conveyance chamber 3. The processing chamber 5 includes a susceptor 51 as a support pedestal that holds the wafers W together with the tray 7, and a plasma processing unit 52 (FIG. 6) that performs plasma processing to the wafers W held by the susceptor 51.

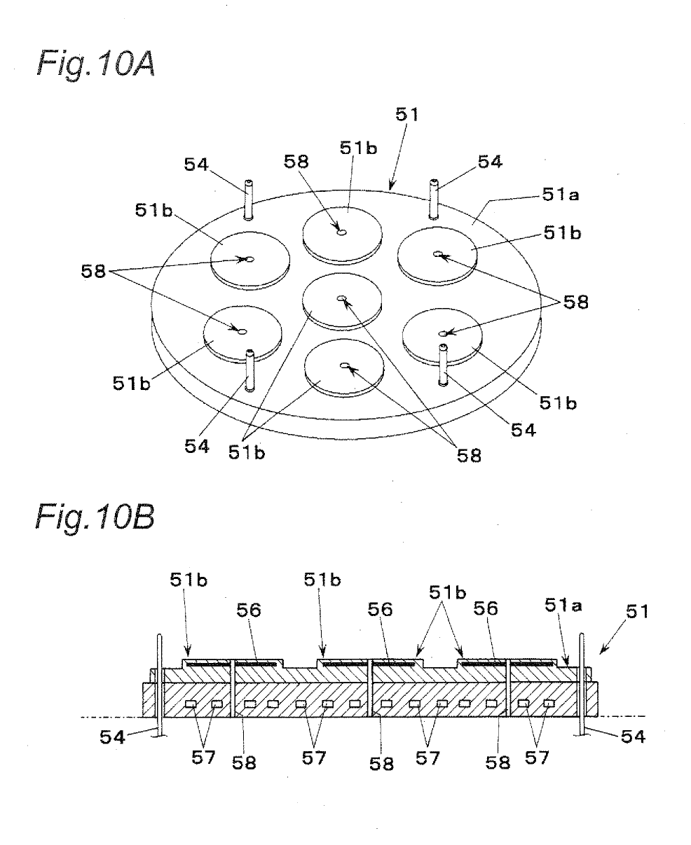

In FIGS. 10A and 10B, the susceptor 51 includes a tray placing portion 51a and a plurality of wafer holding portions 51b provided to project upwardly from the tray placing portion 51a. On the tray placing portion 51a, the tray 7 (each accommodation hole 7a of the tray 7 accommodates the wafer W) having undergone the center position alignment (centering) relative to the rotary table 41 and the positioning in the rotation direction in the alignment chamber 4, and conveyed by the conveyance arm 31 in the conveyance chamber 3 is placed. When the tray 7 having undergone the centering and the rotation direction positioning is placed on the tray placing portion 51a, each wafer holding portion 51b enters corresponding accommodation hole 7a of the tray 7 from below to lift and hold the wafer W.

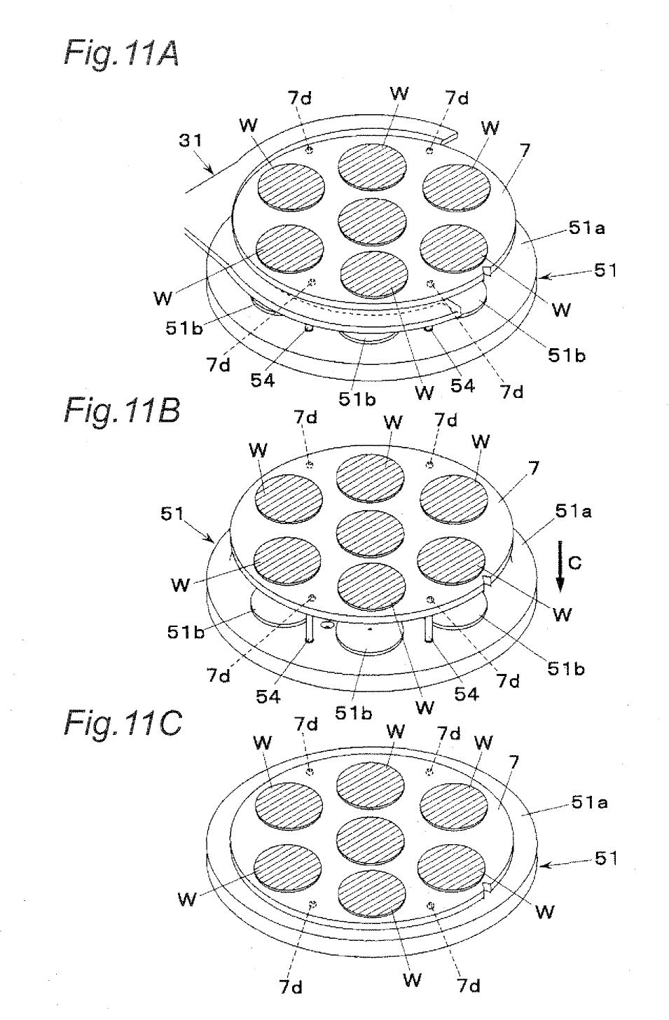

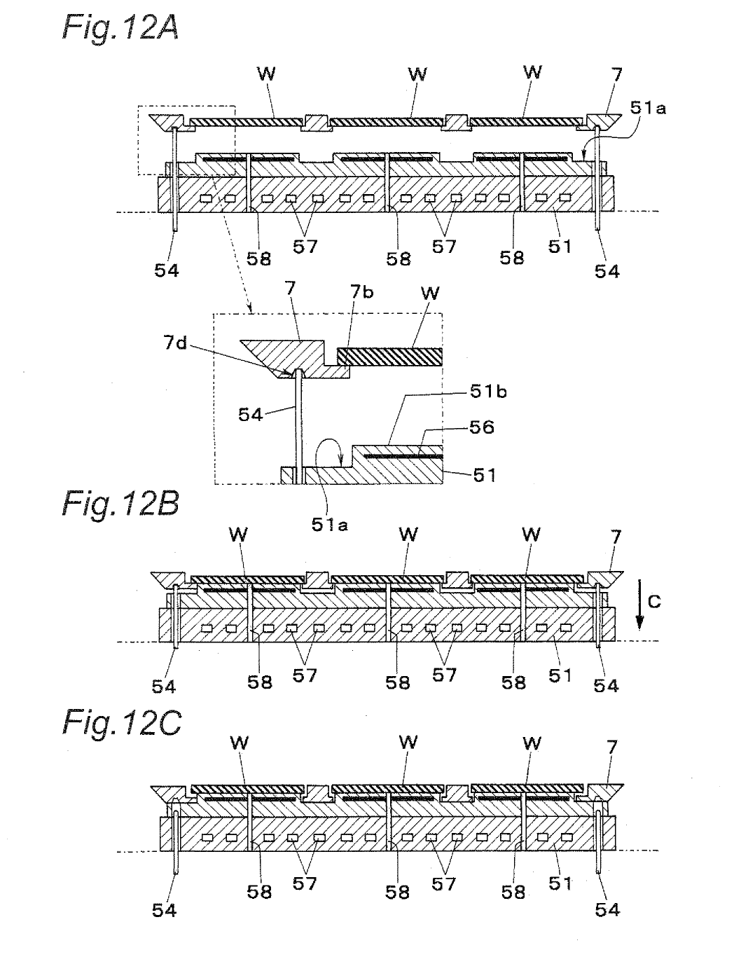

In FIG. 10A, the susceptor 51 is provided with four up-and-down pins 54 that go up and down in synchronization by the actuation of an up-and-down pin driving mechanism 53 (FIG. 6) controlled by the control apparatus 6. The top end portions of the four up-and-down pins 54 are structured such that four up-and-down pin fitting holes 7d (FIGS. 5A and 5B) provided on the bottom face side of the tray 7 can be fitted therewith from above. In the state where the four up-and-down pin fitting holes 7d of the tray 7 are fitted with the four up-and-down pins 54 (FIGS. 11A and 12A), the four up-and-down pins 54 are lowered relative to the susceptor 51 (arrow C in FIGS. 11B and 12B). By this lowering, the tray 7 is placed on the tray placing portion 51a, and the wafer W accommodated in each accommodation hole 7a of the tray 7 is held so as to float above the tray 7 by the wafer holding portion 51b entering in each accommodation hole 7a from below (FIGS. 11C and 12C).

In FIG. 6, the plasma processing unit 52 includes a gas supplying source 52a, a vacuum evacuating apparatus 52b, a first high-frequency voltage applying apparatus 52c, a DC voltage applying apparatus 52d, a coolant circulating apparatus 52e, a cooling gas supplying apparatus 52f, and a second high-frequency voltage applying apparatus 52g, each of whose operation is controlled by the control apparatus 6 (FIG. 6). The gas supplying source 52a supplies gas for generating plasma into the processing chamber 5. The vacuum evacuating apparatus 52b evacuates the gas in the processing chamber 5 to create a vacuum. The first high-frequency voltage applying apparatus 52c applies a high-frequency voltage to the induction coil 55 (FIG. 3) provided above the processing chamber 5. The DC voltage applying apparatus 52d applies a DC voltage to an electrostatic attraction-purpose electrode 56 (FIG. 10B) provided to each of the wafer holding portion 51b, to thereby electrostatically attract the wafer W placed on the wafer holding portion 51b onto the wafer holding portion 51b. The coolant circulating apparatus 52e allows the coolant whose temperature is adjusted to circulate in the coolant flow channel 57 (FIG. 10B), which is provided in the susceptor 51. The cooling gas supplying apparatus 52f supplies a cooling gas (e.g., helium gas) for cooling the wafers W to a cooling gas supplying duct 58 (FIGS. 10B, 12A, 12B, and 12C) that is provided in the susceptor 51 and opens at the top face of the wafer holding portion 51b. The second high-frequency voltage applying apparatus 52g generates bias that attracts the plasma generated in the processing chamber 5 toward the wafers W.

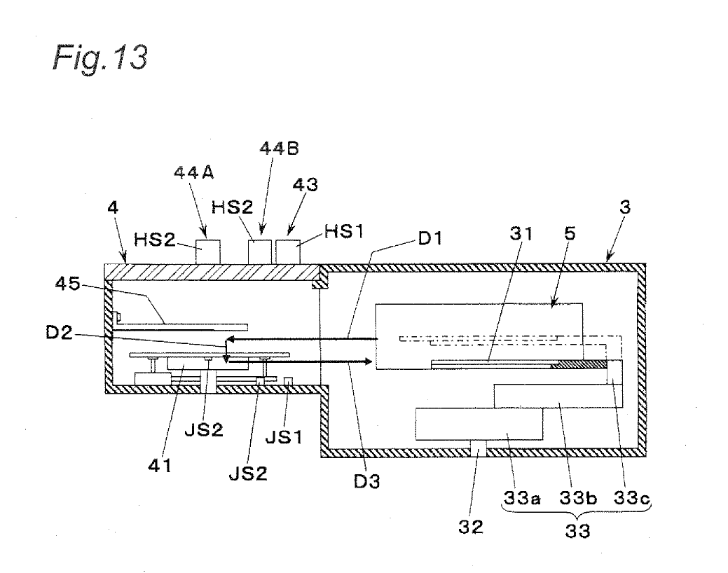

Next, a description will be given of the procedure in which the plurality of wafers W are subjected to plasma processing by a batch process by the plasma processing apparatus 1. The control apparatus 6 firstly shifts the conveyance arm 31, and allows the conveyance arm 31 to hold one of a plurality of the trays 7 (the wafer W is accommodated in each of the accommodation holes 7a of each of the trays 7) supplied to the stock unit 2. Thereafter, the control apparatus 6 actuates the conveyance arm 31 to shift the tray 7 in the alignment chamber 4 (arrow D1 in FIG. 13). Further, the control apparatus 6 lowers the conveyance arm 31 above the rotary table 41, to place the tray 7 on the rotary table 41 (arrow D2 in FIG. 13). After the control apparatus 6 places the tray 7 on the rotary table 41, the control apparatus 6 returns the conveyance arm 31 inside the conveyance chamber 3 (arrow D3 in FIG. 13).

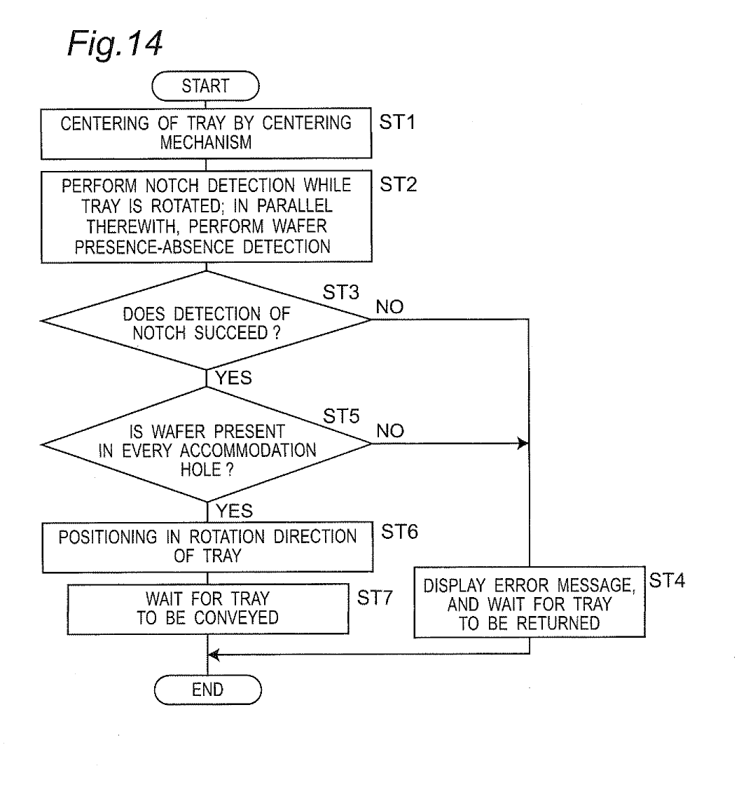

The control apparatus 6 places the tray 7 on the rotary table 41 of the alignment chamber 4 in the foregoing manner, and thereafter exerts the actuation control of the centering mechanism driving unit 42d to actuate the centering mechanism 42, to perform centering of the tray 7 in the manner described in the foregoing (Step ST1 in FIG. 14). Then, when the centering of the tray 7 is finished, the rotary table 41 is actuated to rotate the tray 7 by 360 degrees or more within a horizontal plane. Thus, detection of the notch 7c provided at the tray 7 is performed using the notch detecting sensor 43.

Further, the control apparatus 6 executes the wafer presence-absence detection in parallel with the detection of the notch 7c performed by the notch detecting sensor 43. That is, when the rotary table 41 is actuated to rotate the tray 7 for detection of the notch 7c and the tray 7 is rotated, the two wafer presence-absence detecting sensors (the first wafer presence-absence detecting sensor 44A and the second wafer presence-absence detecting sensor 44B) perform the wafer presence-absence detection as to each of the accommodation holes 7a of the tray 7 (Step ST2 in FIG. 14). Accordingly, the time required for processing in the alignment chamber 4 can be shortened. This contributes towards the takt time improvement of the whole plasma processing apparatus 1. Further, since the presence-absence detection of wafers W is performed while the tray 7 is rotated by the rotary table 41, the six accommodation holes 7a other than the accommodation hole 7a at the center of the tray 7 can be subjected to the wafer presence-absence detection by the single wafer detecting sensor 44B whose projection direction of the inspection light is fixed. In Step ST2, after the control apparatus 6 finishes the wafer presence-absence detection as to the accommodation holes 7a, the control apparatus 6 stops the rotation of the tray 7 (rotation of the rotary table 41) at the time point where the notch 7c is detected, to thereby grasp the origin position of the rotation direction of the tray 7.

After Step ST2 is finished, the control apparatus 6 determines whether or not detection of the notch 7c has succeeded (Step ST3 in FIG. 14). Then, as a result, when it is determined that detection of the notch 7c in Step ST2 has failed, an error message is displayed on a display unit (alarm issuing unit) 61 (FIG. 6) such as a display apparatus provided to the plasma processing apparatus 1. Thereafter, the control apparatus 6 enters the standby state for returning the tray 7 to the stock unit 2 (Step ST4 in FIG. 14). It is to be noted that, the number of times of rotation of the rotary table 41 in detecting the notch 7c in Step ST2 is fixed to a predetermined number of times (e.g., three). When the control apparatus 6 cannot detect the notch 7c by the time when the rotary table 41 has been rotated the predetermined number of times, the control apparatus 6 determines that detection of the notch 7c has failed, and the process proceeds from Step ST3 to Step ST4.

On the other hand, when the wafer presence-absence determining unit 6b of the control apparatus 6 determines that the notch 7c is successfully detected in Step ST3, the control apparatus 6 determines that whether or not the wafer W is present in every accommodation hole 7a provided to the tray 7, based on the result of Step ST2 (Step ST5 in FIG. 14).

In Step ST5, when the wafer presence-absence determining unit 6b does not determine that the wafer W is present in every accommodation hole 7a provided to the tray 7, that is, when the wafer presence-absence determining unit 6b determines that there is any accommodation hole 7a in which no wafer W is present among the seven accommodation holes 7a provided to the tray 7 (no wafer), an error message (alert) is displayed on the display unit 61 (Step ST4 in FIG. 14). The manner of the error message displayed on the display unit 61 may be of any of the following so long as the operator can recognize the message: letters, graphics, symbols, lamp flashing and the like. Further, a sound output unit that outputs an error message (alert) by sound or voice may be provided in addition to or in place of the display unit 61.

Further, when it is determined that there is any accommodation hole 7a in which no wafer W is present among the seven accommodation holes 7a provided to the tray 7 (no wafer), the control apparatus 6 enters the standby state for returning the tray 7 to the stock unit 2 (Step ST4 in FIG. 14). The standby state ends when the condition for returning the tray 7 to the stock unit 2 is satisfied. After the standby state ends, the control apparatus 6 holds the tray 7 on the rotary stage 41 with the conveyance arm 31 of the conveying mechanism 30, and returns the tray 7 from the alignment chamber 4 to the cassette 21 in the stock unit 2.

On the other hand, when the wafer presence-absence determining unit 6b determines that a wafer W is present in every accommodation hole 7a provided to the tray 7 in Step ST5 (wafer present), the control apparatus 6 rotates the rotary table 41, to perform the positioning in the rotation direction of the tray 7 based on the position of the notch 7c detected in Step ST2 (Step ST6 in FIG. 14). Further, the control apparatus 6 enters the standby state for conveying the tray 7 to the processing chamber 5 (Step ST7 in FIG. 14), and ends the process in the alignment chamber 4.

When the wafer presence-absence determining unit 6b determines that no wafer W is present in any of the accommodation holes 7a (no wafer) and the standby state in Step ST4 is entered, the control apparatus 6 actuates the conveyance arm 31 and returns the tray 7 on the rotary table 41 to the stock unit 2.

In this manner, with the plasma processing apparatus 1 according to the present embodiment, at the stage before the plasma processing is performed to the wafers W where the tray 7 is held by the rotary table 41, detection as to whether or not the wafer W is present in each of the accommodation holes 7a provided to the tray 7 (the wafer presence-absence detection) is performed. As a result, in the case where there is any accommodation hole 7a in which no wafer W is present among the plurality of accommodation holes 7a, the tray 7 is not conveyed to the processing chamber 5.

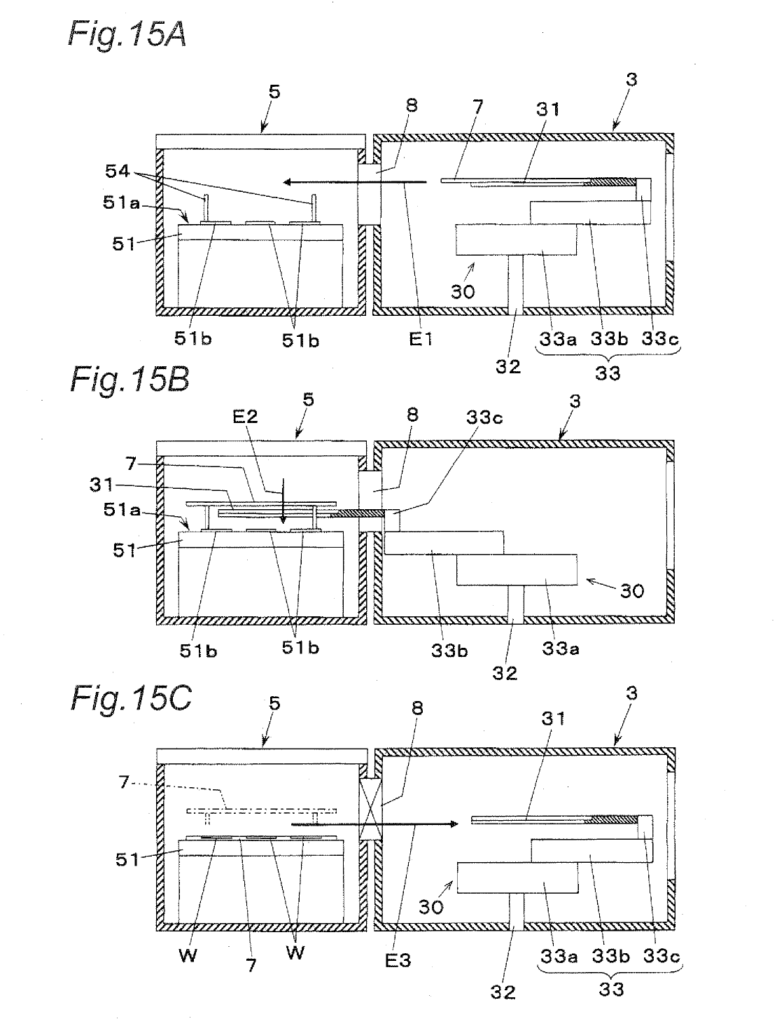

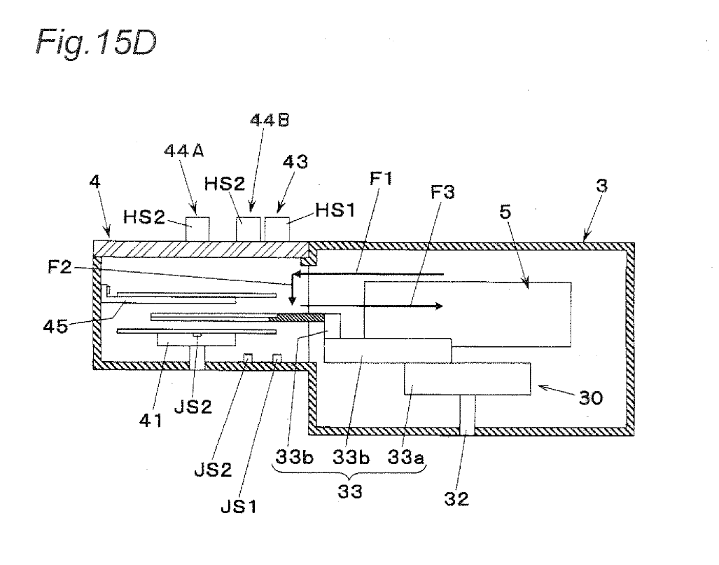

When the wafer presence-absence determining unit 6b determines that the wafer W is present in every accommodation hole 7a and the standby state in Step ST7 is entered, the control apparatus 6 actuates the conveyance arm 31 so as to hold the tray 7 on the rotary table 41, and to place the tray 7 on the susceptor 51 of the processing chamber 5 via the conveyance chamber 3. This operation is represented by arrow E1 in FIG. 15A and arrow E2 in FIG. 15B. Here, since the tray 7 has already undergone the center position alignment (centering) relative to the rotary table 41 and the positioning in the rotation direction in the alignment chamber 4, the top end portions of the four up-and-down pins 54 provided at the susceptor 51 fit in the four up-and-down pin fitting holes 7d provided on the bottom face side of the tray 7. Thus, the tray 7 is held by the four up-and-down pins 54.

When the control apparatus 6 allows the tray 7 to be held by the four up-and-down pins 54, the control apparatus 6 allows the conveyance arm 31 to recede from the processing chamber 5 (arrow E3 in FIG. 15C). Then, the control apparatus 6 closes the gate valve 8 provided at the processing chamber 5 so that the processing chamber 5 enters the sealed state.

After the control apparatus 6 establishes the sealed state of the processing chamber 5, the control apparatus 6 exerts the actuation control of the up-and-down pin driving mechanism 53 so as to lower the four up-and-down pins 54. This lowering allows the tray 7 to be placed on the tray placing portion 51a of the susceptor 51, and the wafers W accommodated in the accommodation holes 7a of the tray 7 to be placed on (held by) the wafer holding portions 51b of the susceptor 51 (FIG. 15C).

After the control apparatus 6 allows the tray 7 and the wafers W to be placed on the susceptor 51, the control apparatus 6 performs the actuation control of the gas supplying source 52a so as to supply gas for generating plasma in the processing chamber 5. Next, the DC voltage applying apparatus 52d is actuated so as to apply a DC voltage to the electrostatic attraction-purpose electrodes 56 in the wafer holding portions 51b. Thus, the wafers W on the wafer holding portions 51b are electrostatically attracted to the electrostatic attraction-purpose electrodes 56.

When the control apparatus 6 senses that the gas for generating plasma supplied into the processing chamber 5 is adjusted to a predetermined pressure, the control apparatus 6 exerts the actuation control of the first high-frequency voltage applying apparatus 52c so as to apply a high-frequency voltage to the induction coil 55. Thus, plasma is generated inside the processing chamber 5.

After the wafers W are held on the wafer holding portions 51b by the electrostatic attraction, the control apparatus 6 actuates the cooling gas supplying apparatus 52f such that the bottom face of the wafer holding portions 51b is filled with the cooling gas from the cooling gas supplying duct 58. Further, the control apparatus 6 exerts the actuation control of the second high-frequency voltage applying apparatus 52g, so that the plasma in the processing chamber 5 is attracted to the wafers W on the wafer holding portions 51b. Thus, the wafer processing (etching) to the wafers W is started.

When a predetermined time has elapsed from the start of the plasma processing to the wafers W, the control apparatus 6 stops the application of the bias voltage to the electrostatic attraction-purpose electrodes 56 by the second high-frequency voltage applying apparatus 52g, to thereby stop plasma generation in the processing chamber 5. Next, the control apparatus 6 exerts the actuation control of the cooling gas supplying apparatus 52f so as to stop supply of the cooling gas. After the cooling gas supply has stopped, at the timing where the pressure of the cooling gas at the bottom face of the wafer W has fully reduced, the control apparatus 6 stops supply of the gas from the gas supplying source 52a to the processing chamber 5, and stops application of the high-frequency voltage to the induction coil 55 by the first high-frequency voltage applying apparatus 52c. Further, the control apparatus 6 stops application of the DC voltage to the electrostatic attraction-purpose electrodes 56 by the DC voltage applying apparatus 52d, to thereby release the electrostatic attraction of the wafers W. After the wafer electrostatic attraction is released, diselectrification is performed as necessary to eliminate electrostatics remaining on the wafers W or the tray 7, and processing in the processing unit ends.

During the processing in the processing chamber 5 described above, the control apparatus 6 constantly causes the vacuum evacuating apparatus 52b to perform the evacuation operation of the gas in the processing chamber 5 to the outside of the plasma processing apparatus 1, and causes the coolant circulating apparatus 52e to perform the circulation operation of coolant into the coolant flow channel 57. By the coolant circulating apparatus 52e performing the coolant circulation operation in the coolant flow channel 57, the wafers W are cooled via the susceptor 51. Thus, high plasma processing efficiency can be retained in synergy with the cooling of the wafers W through the cooling gas.

It is to be noted that, as described above, during the plasma processing to the wafers W in the processing chamber 5, the control apparatus 6 actuates the conveyance arm 31, so as to take out the tray 7 accommodating the wafers W to be subjected to plasma processing next from the stock unit 2, and to convey the tray 7 to the alignment chamber 4. Further, the control apparatus 6 allows the tray 7 to be placed on the rotary table 41. Thus, during execution of the plasma processing to the wafers W in the processing chamber 5, the center position alignment (centering), the positioning in the rotation direction of the rotary table 41, and the presence-absence detection of the wafers W can be performed as to the tray 7 accommodating the wafers W to be subjected to the plasma processing next.

When the plasma processing to the wafers W in the processing chamber 5 is finished, the control apparatus 6 actuates the up-and-down pin driving mechanism 53 to raise the four up-and-down pins 54, so that the tray 7 is lifted and held above the susceptor 51. It is to be noted that, the four up-and-down pins 54 fit in the up-and-down pin fitting holes 7d provided on the bottom face side of the tray 7 from below in the process of raising.

When the tray 7 is lifted and held above the susceptor 51 by the raising actuation of the up-and-down pins 54, the control apparatus 6 opens the gate valve 8 to allow the conveyance arm 31 to enter the processing chamber 5. Further, the control apparatus 6 allows the tray 7 being lifted and held by the up-and-down pins 54 to be retained by the conveyance arm 31, and to leave the processing chamber 5. Then, the control apparatus 6 allows the tray 5 to be placed on the tray temporarily placement table 45 of the alignment chamber 4 (arrows F1 and F2 in FIG. 15D). Subsequently, the tray 7 on the rotary table 41 having undergone the center position alignment (centering) relative to the rotary table 41 and the positioning in the rotation direction (i.e., the tray 7 accommodating the wafers W to be subjected to the plasma processing next) is held by the conveyance arm 31, so that the tray 7 leaves the alignment chamber 4 (arrow F3 in FIG. 15D). Then, the tray 7 is conveyed to the processing chamber 5. After the control apparatus 6 allows the tray 7 accommodating the wafers W to be subjected to the plasma processing next to be conveyed to the processing chamber 5, the control apparatus 6 allows the conveyance arm 31 to enter the alignment chamber 4, so that the tray 7 on the tray temporarily placement table 45 (i.e., the tray 7 accommodating the wafers W having undergone the plasma processing) is held and taken out from the alignment chamber 4, and to be returned to the stock unit 2.

In this manner, the tray 7 conveyed from the processing chamber 5 is temporarily placed on the tray temporarily placement table 45, and is returned to the stock unit 2 after being cooled. Thus, the wafers W (tray 7) are prevented from being returned to the stock unit 2 in the state where the wafers W are kept at high temperatures by the plasma processing. Further, in the state where the tray 7 accommodating the wafers W at high temperatures is still placed on the tray temporarily placement table 45, the tray 7 accommodating the wafers W to be subjected to the plasma processing next is taken out from the alignment chamber 4 and conveyed to the processing chamber 5. Thus, the time required for the whole plasma processing can be shortened and the work can efficiently be performed.

When the tray 7 placed on the tray temporarily placement table 45 is returned to the stock unit 2, the batch process for the wafers W accommodated in the tray 7 ends.

As described in the foregoing, the plasma processing apparatus 1 in the present embodiment includes: the alignment chamber 4 where the positioning of the tray 7 accommodating the wafer W in each of the plurality of (seven herein) accommodation holes 7a; and the processing chamber 5 where the plasma processing is performed to the wafer W accommodated in each of the plurality of accommodation holes 7a of the tray 7. Further, the plasma processing apparatus 1 includes: the rotary table 41 that holds the tray 7 accommodating the wafers W and rotates the tray 7 within the horizontal plane in the alignment chamber 4; the centering mechanism 42 that performs the center position alignment of the tray 7 relative to the rotary table 41 in the alignment chamber 4; and rotation direction positioning means (the notch detecting sensor 43 and the alignment processing unit 6a of the control apparatus 6) for performing positioning in the rotation direction of the tray 7 while the tray 7 is rotated by the rotary table 41 in the alignment chamber 4. Further, the plasma processing apparatus 1 includes: the susceptor 51 (the support pedestal) provided with the tray placing portion 51a on which the tray 7 is placed in the processing chamber 5 and the plurality of wafer holding portions 51b that lift and hold the wafers W by entering the accommodation holes 7a of the tray 7 from below when the tray 7 is placed on the tray placing portion 51a; and the plasma processing unit 52 (the plasma processing means) that performs the plasma processing to the plurality of wafers W held by the plurality of wafer holding portions 51b provided to the susceptor 51. Still further, the plasma processing apparatus 1 includes: the conveyance arm 31 as conveying means for conveying the tray 7 having undergone the center position alignment relative to the rotary table 41 by the centering mechanism 42 and the positioning in the rotation direction by the rotation direction positioning means from the rotary table 41 of the alignment chamber 4 to the susceptor 51 in the processing chamber 5; the two wafer presence-absence detecting sensors 44A and 44B as the wafer presence-absence detecting unit that perform detection as to whether or not the wafer W is present in each of the accommodation holes 7a of the tray 7 held by the rotary table 41 of the alignment chamber 4 (the wafer presence-absence detection); and the wafer presence-absence determining unit 6b of the control apparatus 6.

The plasma processing apparatus 1 according to the present embodiment is structured such that, at the stage of positioning the tray 7 in the alignment chamber 4 before the plasma processing to the wafers W in the processing chamber 5 is performed (i.e., at the stage of centering and positioning in the rotation direction of the tray 7), the detection as to whether or not the wafer W is present in each of the accommodation holes 7a provided to the tray 7 is performed (the wafer presence-absence detection). As a result, in the case where there is any accommodation hole 7a in which no wafer W is present out of the plurality of accommodation holes 7a provided to the tray 7, the tray 7 can be prevented from being placed on the susceptor 51. Thus, it becomes possible to prevent the wafer holding portion 51b from being directly exposed to plasma from the accommodation hole 7a of the tray 7 where no wafer W is present, and hence to prevent not only the wafer holding portion 51b but also the entire plasma processing apparatus 1 from being damaged.

Further, in the plasma processing apparatus 1 according to the present embodiment, the wafer presence-absence determining unit 6b performs detection as to whether or not the wafer W is present in each accommodation hole 7a based on whether or not the inspection light L2 emitted from the wafer presence-absence detecting sensors 44A and 44B to the wafer W accommodated in the tray 7 held by the rotary table 41 is detected. In this manner, since the presence-absence of the wafer W in each accommodation hole 7a is determined based on whether or not the inspection light L2 is blocked by the wafer W, despite its simple structure, the wafer presence-absence determining unit 6b can accurately determine presence or absence of the wafer W in each accommodation hole 7a.

Further, in the plasma processing apparatus 1 according to the present embodiment, the wafer presence-absence detecting unit performs the wafer presence-absence detection while the tray 7 is rotated by the rotary table 41. Thus, the time required for detecting presence or absence of the wafer can be reduced, and the processing work time in the plasma processing apparatus 1 can be reduced.

In the foregoing, though the description has been given of the embodiment of the present invention, the present invention is not limited to the embodiment described above. For example, in the embodiment described above, the tray 7 is structured to accommodate one wafer W in one accommodation hole 7a arranged at the center position, and six wafers W in six accommodation holes 7a having their respective centers disposed at regular intervals on the phantom circle CL about the center position. However, this is merely one example, and the number of wafers W that can be accommodated in the tray 7 or disposition of the accommodation holes 7a can arbitrarily be set.

Further, in the present embodiment, the notch detecting sensor 43 can detect the notch 7c that is formed by cutting out part of the outer edge of the tray 7. The wafer presence-absence detecting means 44A and 44B are only required to be capable of detecting whether or not the wafer W is present in each accommodation hole 7a provided to the tray 7. Accordingly, the sensors 43, 44A, and 44B may not necessarily be the transmission type optical sensors described above, and may each be other sensor such as a reflection type optical sensor (i.e., an optical sensor that is provided with a light projecting unit and a light receiving unit that receives the reflection light of the inspection light projected by the light projecting unit, the light projecting unit and the light receiving unit being provided in an integrated manner). It is to be noted that, in the case where the reflection type optical sensors are used, the light projectors HS1 and HS2 shown in FIG. 7 are to be replaced by the reflection type optical sensors, and the light receivers JS1 and JS2 are to be replaced by mirrors.

In the embodiment described above, the transmission type optical sensors (the wafer presence-absence detecting sensors 44A and 44B) are used as the wafer presence-absence detecting means that detect whether or not the wafer W is present in each of the accommodation holes 7a provided to the tray 7 held by the rotary table 41. However, in place of such optical sensors, an imaging apparatus such as a CCD camera may be used, so that the wafer presence-absence detection may be performed based on an image obtained by imaging the tray 7 on the rotary table 41 from above by the imaging apparatus. In this case, the wafer presence-absence determining unit 6b determines whether or not the wafer W is present in each accommodation hole 7a based on the image imaged by the imaging apparatus. While the tray 7 is rotated by the rotary table 41, by the imaging apparatus such as a CCD camera performing imaging, it becomes possible to detect whether or not the wafer is present in each of the plurality of accommodation holes 7a with one imaging apparatus whose field of view is fixed.

In the embodiment, the mechanism for aligning the tray 7 including the rotary table 41 is disposed in the independent alignment chamber 4. However, the mechanism for aligning the tray 7 including the rotary table 41 may be disposed in the conveyance chamber 3. The present invention is also applicable to this structure.

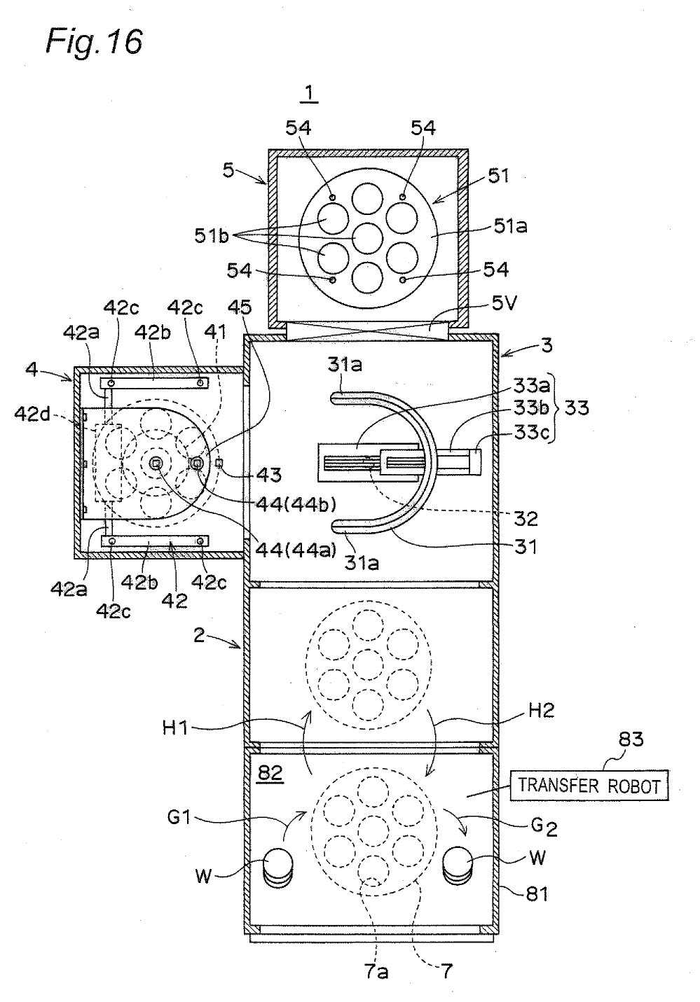

The specific structure related to the stock unit 2 is not limited to the one shown in the embodiment. For example, the plasma processing apparatus 1 according to a modified embodiment shown in FIG. 16 includes a transfer unit 81 provided adjacent to the stock unit 2. From the transfer unit 81, the tray 7 accommodating the wafers W before being processed is supplied to the stock unit 2. The tray 7 is returned from the stock unit 2 to the transfer unit 81 after the wafers W are processed. In a transfer chamber 82 in the transfer unit 81, a transfer robot 83 is accommodated.

The transfer robot 83 performs, as conceptually indicated by arrow G1 in FIG. 16, the work of accommodating the wafers W before being subjected to plasma processing in the accommodation holes 7a of the tray 7, that is, the work of transferring the wafers W to the tray 7. Further, the transfer robot 83 performs, as conceptually indicated by arrow G2 in FIG. 16, the work of transferring the wafers W having been subjected to dry etching from the tray 7. Further, the transfer robot 83 performs the work of transferring the tray 7 accommodating the wafers W before being processed from the transfer unit 81 to the stock unit 2 (arrow H1 in FIG. 16) and the work of transferring the tray 7 accommodating the wafers W having undergone processing from the stock unit 2 to the transfer unit 81 (arrow H2 in FIG. 14).

### INDUSTRIAL APPLICABILITY

What is provided is a plasma processing apparatus that can prevent the wafer holding portion of the support pedestal from being directly exposed to the plasma from the accommodation hole of the tray where no wafer is present.

### Description of Symbols

1 PLASMA PROCESSING APPARATUS
2 STOCK UNIT
3 CONVEYANCE CHAMBER (CONVEYANCE UNIT)
4 ALIGNMENT CHAMBER (ALIGNMENT UNIT)
5 PROCESSING CHAMBER (PROCESSING UNIT)
6a ALIGNMENT PROCESSING UNIT (ROTARY DIRECTION POSITIONING UNIT)
6b WAFER PRESENCE-ABSENCE DETERMINING UNIT
7 TRAY
7a ACCOMMODATION HOLE
30 CONVEYING MECHANISM
31 CONVEYANCE ARM
41 ROTARY TABLE
42 CENTERING MECHANISM
43 NOTCH DETECTING SENSOR (ROTARY DIRECTION POSITIONING UNIT)
44A, 44B WAFER PRESENCE-ABSENCE DETECTING SENSOR
51 SUSCEPTOR (SUPPORT PEDESTAL)
51a TRAY PLACING PORTION
51b WAFER
52 PLASMA PROCESSING UNIT
81 TRANSFER UNIT
82 TRANSFER CHAMBER
83 TRANSFER ROBOT
W WAFER
L INSPECTION LIGHT

1. A plasma processing apparatus, comprising:
a stock unit for supplying and collecting a conveyable tray that accommodates a wafer in each of a plurality of accommodation holes penetrating through in a thickness direction;
a processing unit that performs plasma processing to each wafer accommodated in the tray supplied from the stock unit;
an alignment unit that has a table on which the tray before being subjected to the plasma processing is placed, positioning of the wafer on the table being performed at the alignment unit; and
a wafer presence-absence detecting unit that detects whether or not the wafer is present in each of the accommodation holes of the tray placed on the table of the alignment unit.

2. The plasma processing apparatus according to claim 1, further comprising:
a conveying mechanism that conveys the tray; and
a conveyance control unit that causes the tray on the table to be returned to the stock unit instead of the tray being conveyed to the processing unit by the conveying mechanism, when the wafer presence-absence detecting unit detects that the wafer is not accommodated in any of the accommodation holes of the tray placed on the table.

3. The plasma processing apparatus according to claim 2, wherein the wafer presence-absence detecting unit includes:
an optical sensor for detecting the wafer accommodated in each of the accommodation holes of the tray on the table; and
a determining unit that determines whether or not the wafer is present in each of the accommodation holes provided to the tray, based on a signal from the optical sensor.

4. The plasma processing apparatus according to claim 3, wherein the optical sensor includes:
a light projector that projects inspection light toward the tray; and
a light receiver that is arranged at a position where the inspection light is blocked and unreceived when the wafer is accommodated in any of the accommodation holes of the tray, and where the inspection light is received when the wafer is not accommodated in any of the accommodation holes of the tray.

5. The plasma processing apparatus according to claim 1, wherein the wafer presence-absence detecting unit includes:
an imaging unit that images the accommodation holes of the tray on the table from above; and
a determining unit that determines whether or not the wafer is present in each of the accommodation holes of the tray, based on an image obtained by the imaging unit.

6. The plasma processing apparatus according to claim 1, wherein the table is a rotary table that rotates the tray within a horizontal plane, and
wherein the wafer presence-absence detecting unit detects whether or not the wafer is present in each of the accommodation holes provided to the tray, while the tray is rotated by the rotary table.

7. The plasma processing apparatus according to claim 6, wherein the alignment unit includes:
a centering mechanism that performs center position alignment of the tray relative to the rotary table; and
a rotary direction positioning unit that performs positioning in a rotation direction of the tray while the tray is rotated by the rotary table, and
wherein the wafer presence-absence detecting unit detects whether or not the wafer is present in each of the accommodation holes provided to the tray, while the positioning in the rotation direction is performed by the rotary direction positioning unit.

8. The plasma processing apparatus according to claim 1, further comprising:
an alarm issuing unit that issues an alarm when the wafer presence-absence detecting unit detects that the wafer is not accommodated in any of the accommodation holes of the tray.

9. A plasma processing method, comprising:
conveying from a stock unit to an alignment unit a tray that accommodates a wafer in each of a plurality of accommodation holes penetrating through in a thickness direction, and placing the tray on a table;
detecting whether or not the wafer is present in each of the accommodation holes of the tray on the table of the alignment unit;
conveying the tray from the alignment unit to the processing unit when the wafer is present in each of the accommodation holes of the tray on the table, and executing plasma processing; and
returning the tray from the alignment unit to the stock unit when the wafer is absent in any of the accommodation holes of the tray on the table.
